(19) United States
(12) Patent Application Publication
(10) Pub. No.: US 2006/0054229 A1
(43) Pub. Date: Mar. 16, 2006

(54) Valve assemblies principally for automatic swimming pool cleaner

(76) Inventors: Hendrikus Johannes van der Meijden, Midrand (ZA); Peter Hugh Harrison, Irene (ZA); Michael Edward Moore, Johannesburg (ZA); Mark J. Bauckman, Deerfield Beach, FL (US)

Correspondence Address: John S. Pratt, Esq.;KILPATRICK STOCKTON LLP, Suite 2800, 1100 Peachtree Street, Atlanta, GA, 30309-4530, US

(21) Appl. No.: 10/939,579

(22) Filed: Sep. 13, 2004

(51) Int. Cl. F16K 15/14

(52) U.S. Cl. 137/849

(57) ABSTRACT

Detailed are valves principally useful for automatic swimming pool cleaners. The valves may be made of flexible material and, typically, are generally tubular in shape. Mouths of the valves may be divided into two or more parts, with certain versions having three lobes. These configurations enable larger debris to pass through the valves.

### FIELD OF THE INVENTION

This invention relates principally to components of devices for cleaning fluid-containing vessels and more particularly, but not exclusively, to valve assemblies for water interruption-type automatic cleaners for swimming pools.

### BACKGROUND OF THE INVENTION

Commonly-owned U.S. Pat. No. 4,642,833 to Stoltz, et al. (the “Stoltz Patent”), whose contents are incorporated herein in their entirety by this reference, discloses various valve assemblies useful for automatic swimming pool cleaners. These assemblies typically include flexible, generally tubular diaphragms surrounded by chambers, with the diaphragms interposed in the main fluid-flow paths through the cleaners. In response to variation in pressure internally and externally, the diaphragms contract and expand transversely along at least part of their lengths, thereby controlling fluid flow therethrough.

Mentioned in the Stoltz Patent is that versions of the diaphragms may have “substantially oval-shaped or diamond-shaped cross section . . . when a total fluid flow interruption is to be achieved.” See Stoltz Patent, col. 3, 11. 36-38. Also detailed in the Stoltz Patent is use of longitudinal ribs “along that part [of a diaphragm] which contracts to the greatest extent.” See id., col. 5, 11. 32-33. According to the Stoltz Patent, such ribs enable a diaphragm to contract to an X-shaped pattern depicted in FIG. 7 of the patent. See id., 11.33-35.

Commonly-owned U.S. Pat. No. 4,742,593 to Kallenbach (the “Kallenbach Patent”), the contents of which also are incorporated herein in their entirety by this reference, discloses additional valve assemblies for use with automatic swimming pool cleaners. These assemblies too are generally tubular in shape and made of flexible material. As noted in the Kallenbach Patent:

The body [of the tubular valve] has an intermediate section between the ends that assumes a substantially collapsed condition over a segment thereof in absence of a pressure differential between the interior and exterior. The section preferably is collapsed transversely over a segment.

Along the collapsed segment, the body has diverging interior walls in the direction of water flow therethrough. The walls diverge from a substantially constant diameter that extends for a portion of the section adjacent the first end to a substantially constant, but larger, diameter that extends for a portion of the section adjacent the second end. Further, the divergence is a substantially linear function of the distance along the segment. See Kallenbach Patent, col. 1, 11.28-42.

U.S. Pat. No. 6,098,228 to Chang (the “Chang Patent”), entitled “Pool Cleaner Diaphragm Valve,” likewise addresses diaphragm-style valves and ancillary assemblies for automatic swimming pool cleaners. Apparently, however, these valves are of the type specified in the Kallenbach Patent. Indeed, according to the Chang Patent, this type of valve “is ideal” for the purposes described therein. See Chang Patent, col. 6, 11. 60-65.

### SUMMARY OF THE INVENTION

The present invention provides alternatives to the valves of the Stoltz and Kallenbach Patents. Unlike existing diaphragm-type valves, diaphragm valves of the present invention include mouths divided into two or more, and preferably three, parts. This configuration admits a larger through hole within the valves, in turn enabling larger debris to pass. Consequently, use of the present valves may reduce any tendency of the valves to clog when contacted at their mouths by debris entrained within the fluid flowing through the valves.

Advantageously (but not necessarily), valves of the present invention may be generally tubular in shape and, at least in part, made of elastomeric or other flexible, rubber-like material. Such valves typically will be placed in-line within the operating head of an automatic swimming pool cleaner between its inlets and outlets. Because pool water is induced by a pump to flow through the head, at least some of that water must pass through the in-line valve.

In some embodiments of the valves, mouths are not positioned at either end but rather in a transversely-collapsed section intermediate the ends. Conceivably, however, the mouth could be positioned at either the inlet or the outlet of the valve. The mouth normally is closed (or substantially so), thereafter opening and closing cyclically when connected to an operating pump.

Certain presently-preferred versions of the innovative valves are sized so as to substitute directly for commercial versions of the valves of the Kallenbach Patent. Valves of the present invention need not be so sized, however. Instead, they may be dimensioned in any manner appropriate for the objectives to be accomplished or as desired.

Valves of the present invention may include reinforcing material on either or both of their internal and external surfaces. Such material may, but need not necessarily, be in the form or shape of ribs extending longitudinally along portions of the exterior of the valves. If present, such ribs preferably will be adjacent the outlets of the valves so as to diminish the possibility of undesired collapse of the valves at their outlet ends.

It thus is an optional, non-exclusive object of the present invention to provide valves for water interruption-type automatic swimming pool cleaners.

It is another optional, nonexclusive object of the present invention to provide valves made of flexible material and through which debris-laden fluid may flow.

It is also an optional, non-exclusive object of the present invention to provide valves having mouths divided into three parts.

It is, moreover, an optional, non-exclusive object of the present invention to provide valves capable of ingesting debris of greater size than heretofore ingested with commercially-available diaphragm-type valves.

It is a further optional, non-exclusive object of the present invention to provide automatic swimming pool cleaners containing innovative valves.

Other objects, features, and advantages of the present invention will be apparent to those skilled in the relevant field with reference to the remaining text and drawings of this application.

### BRIEF DESCRIPTION OF THE DRAWINGS

FIGS. 1-2 are perspective views of an exemplary valve of the present invention.

FIG. 3 is a longitudinally cross-sectioned view of the valve of FIGS. 1-2.

FIG. 4 is a transversely cross-sectioned view of the valve of FIGS. 1-2.

FIG. 5 is a plan view of the valve of FIGS. 1-2.

FIG. 6 is a partially cross-sectioned, partially schematicized view of an exemplary automatic swimming pool cleaner containing the valve of FIGS. 1-2.

### DETAILED DESCRIPTION

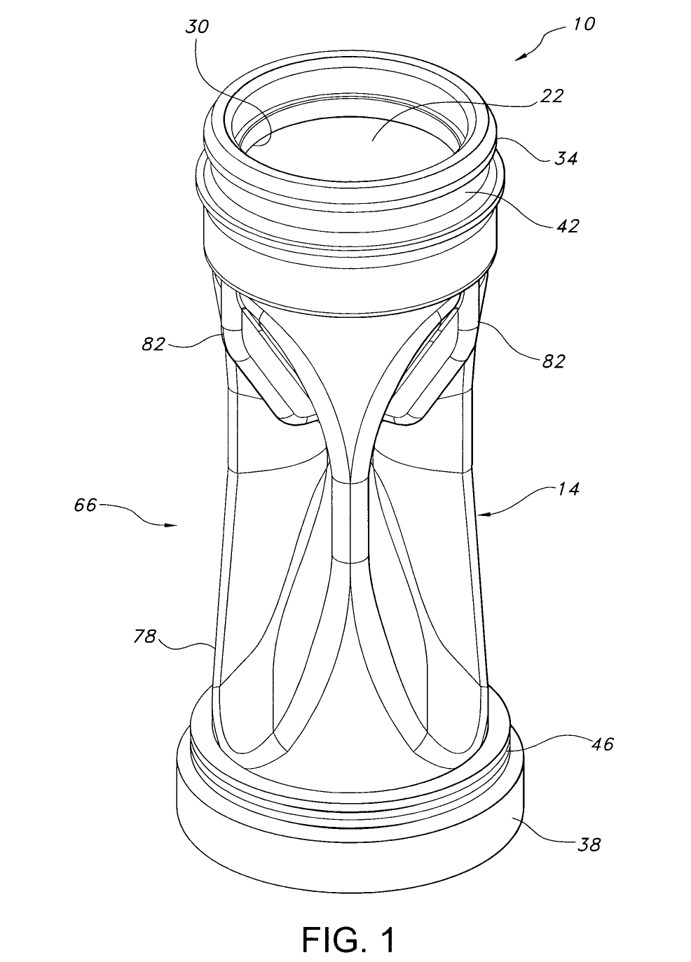

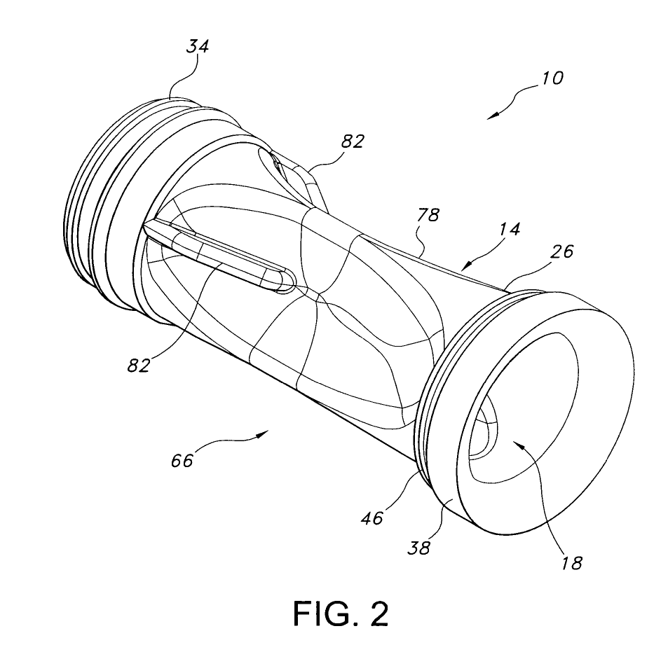

Depicted in FIGS. 1-2 is exemplary valve 10 of the present invention. Valve 10 comprises body 14 together with inlet 18 and outlet 22. Body 14 has exterior surface 26 and interior surface 30 and preferably, although not necessarily, is generally tubular in shape. Body 14 typically is formed of flexible, rubbery material and molded as a single part; those skilled in the appropriate art will, however, recognize that other types of body 14 may be suitable instead.

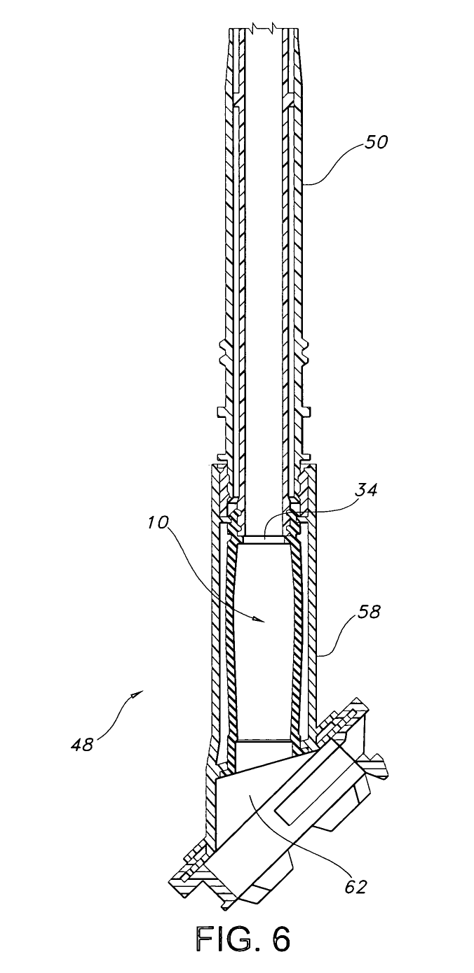

Illustrated in FIGS. 1-2 are collars 34 and 38, recess 42, and one or more flexible sealing rings 46 of body 14 useful for, among other things, connecting valve 10 to components of automatic swimming pool cleaner 48 (see FIG. 6). Collar 34 and recess 42, forming part of exterior surface 26 at or adjacent outlet 22, typically interlock directly or indirectly with extension pipes 50 of cleaner 48 so as to fix the position of outlet 22 relative to the pipes (which in turn typically connect directly or indirectly to a flexible hose). Collar 38 and rings 46, forming part of exterior surface 26 at or adjacent inlet 18, connect body 14 of valve 10 to components within head 58 of cleaner 48 adjacent its mouth 62. None of collars 34 or 38, recess 42, or rings 46 need necessarily be present on body 14, however, as other connecting mechanisms may be used instead.

Preferably, valve 10 is positioned in the main fluid flow path within cleaner 48. If so positioned, fluid in the form of water entering mouth 62 must pass through body 14 of valve 10 before exiting via pipes 50. Entrained in the water stream typically will be debris (e.g. sticks, leaves, etc.), some or all of which also must pass through valve 10 and may tend to clog the passage defined by interior surface 30 of body 14.

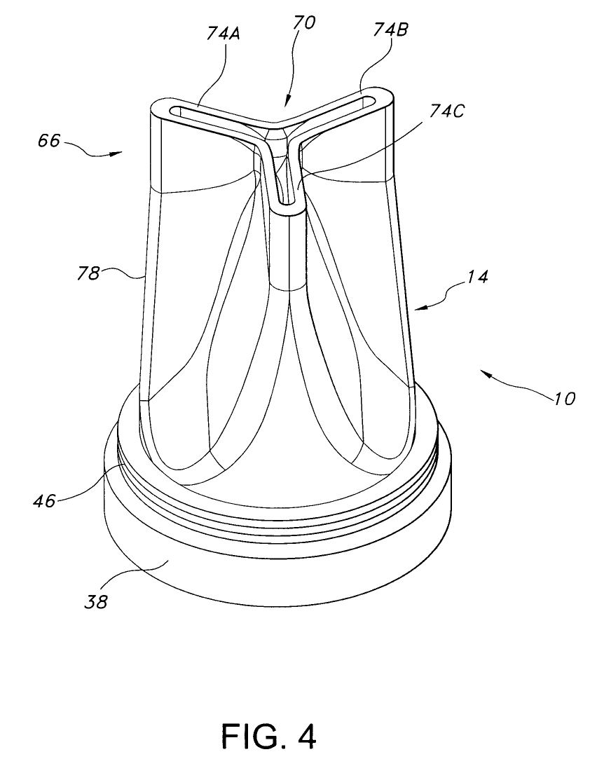

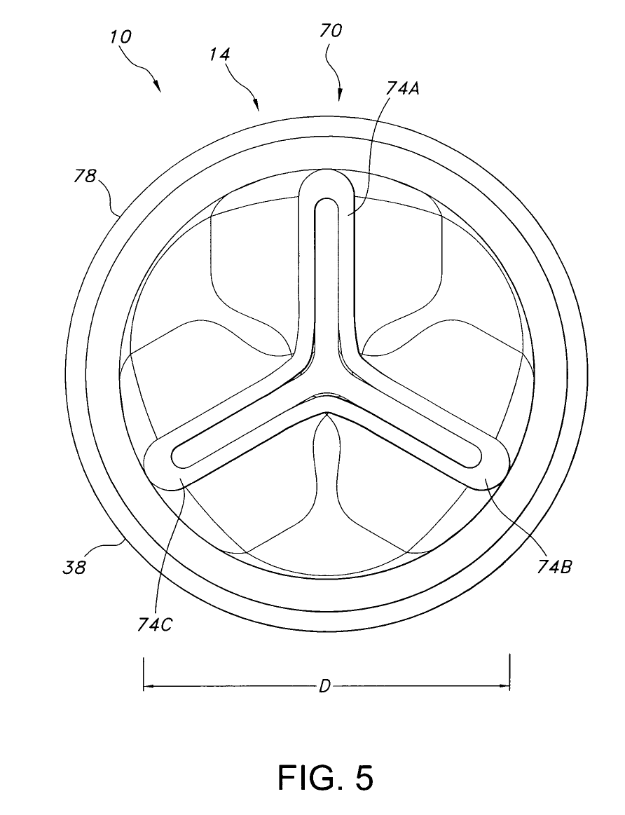

Intermediate inlet 18 and outlet 22 of valve 10 is section 66. As illustrated in each of FIGS. 1-5, section 66 beneficially is collapsed transversely so as to form mouth 70 of body 14. FIGS. 4-5, especially, detail a preferred mouth 70 having three lobes 74A-C defined by wall 78 of body 14, with lobes 74A-C effectively intersecting at non-zero angles in the transverse center of the fluid-flow passage formed by body 14. Such a “tri-lobe” mouth 70 (i.e. with adjacent lobes separated radially by approximately one hundred twenty degrees) offers multiple advantages over the collapsed segment of the valve of the Kallenbach Patent, whose transverse cross-section is generally rectangular in shape. In particular, mouth 70 may open to significantly greater extent than the corresponding segment of the valve of the Kallenbach patent, presenting a larger-diameter fluid flow path and enabling passage of debris of greater size. Stated differently, under certain operating conditions tri-lobe mouth 70 is less likely to clog with debris than is that of the valve of the Kallenbach Patent.

Because mouth 70 normally is of size substantially smaller than the maximum internal diameter D of body 14, it is considered to be “normally closed” (even though mouth 70 need not necessarily ever close completely). As noted in the Kallenbach Patent, utilizing such a normally closed valve provides for easier starting of operation of cleaner 48. It also places valve 10 under less stress in opening than would a normally-open configuration.

During operation of cleaner 48, mouth 70 repeatedly will expand (open) and return (contract) to its normal position, doing so in a cyclical, or periodic, fashion under influence of a pump. Typically, a fluid-filled chamber forming part of cleaner 48 will surround valve 10. If the chamber is partially evacuated of fluid, a differential pressure may be created between the interior of body 14 of valve 10 and exterior surface 26 of body 14, pulling wall 78 outward and causing mouth 70 to open to a diameter approximating that of diameter D. However, absent such manipulative pressure differential across wall 78, the resilient material of valve 10 will cause mouth 70 to remain in its normally-closed position.

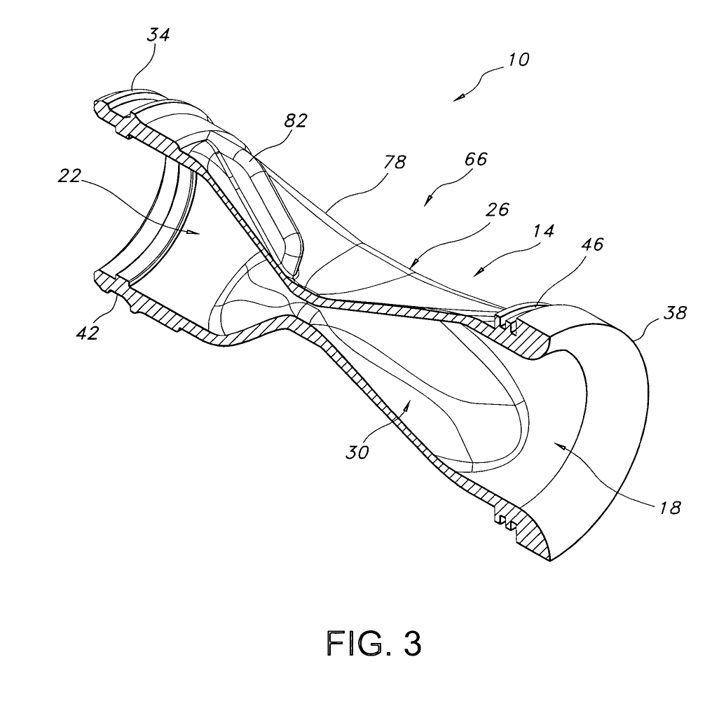

Depicted in the cross-sectional representation of FIG. 3 is the convergent and divergent nature of wall 78. Wall 78 is substantially cylindrical at inlet 18, where body 14 assumes its maximum internal diameter D. Progressing toward mouth 70, wall 78 converges, thus reducing the internal diameter of body 14 to its minimum at mouth 70. Thereafter wall 78 diverges progressing toward outlet 22, whose internal diameter is again approximately that of maximum internal diameter D. Although FIG. 3 illustrates a preferred version of valve 10, wall 78 need not be configured as depicted therein, and the internal diameter of body 14 need not necessarily vary along its length or, if varying longitudinally, need not vary exactly as shown in FIG. 3.

Section 66 may (but need not necessarily) include one or more reinforcing ribs 82 on exterior surface 26. In some versions of valve 10, preferably three such ribs 82 are present, one associated with each lobe 74A-C of mouth 70. Such one-to-one association between ribs 82 and lobes 74A-C need not necessarily exist, however, as fewer or greater than three ribs 82 may be employed even if a tri-lobe mouth 70 is used. (Moreover, mouth 70 itself need not necessarily have three lobes 74A-C, but rather may have fewer or greater numbers of lobes.) Ribs 82, if present, beneficially extend along the length of section 66 from a position at or near outlet 22 to a central region adjacent mouth 70.

Similar to ribs of the valve of the Kallenbach Patent, ribs 82 function to stiffen valve 10 in the axial or longitudinal direction. The stiffness facilitates valve 10 resisting forces acting on it during closure of mouth 70, reducing likelihood of section 66 collapsing (undesirably) in the vicinity of outlet 22. In some versions of valve 10, ribs 82 are molded with and formed of the same material as body 14. Ribs 82 may, however, be formed of material differing from that used to form body 14. Although not detailed in the figures, other ribbing or stiffening material may be formed with or attached to either or both of exterior surface 26 and interior surface 30.

However, because the tri-lobe structure of valve 10 provides substantial strength in the area of outlet 22, ribs 82 likely may be omitted without degrading performance of cleaner 48. Indeed, omitting ribs 82 conceivably could enhance performance of cleaner 48 by not encumbering the opening stroke of body 14, permitting mouth 70 to open wider and in turn permitting more water and debris to pass through and offering less restriction to flow. The stronger geometric structure produced by the tri-lobe design additionally provides excellent resistance to fluid flow when mouth 70 contracts, resulting in good water-interruption power being supplied to move cleaner 48. These results, further, may occur notwithstanding that materials from which valve 10 are made may be substantially more flexible than commercial versions of valves constructed as described in the Kallenbach Patent.

Regardless of whether any ribs 82 are present, because mouth 70 may expand substantially in use, objects of size approximating that of maximum internal diameter D may pass through body 14 from inlet 18 to outlet 22. Thus, a valve 10 sized to replace a valve of the Kallenbach Patent may provide substantially better debris-ingesting performance without clogging. Increasing maximum internal diameter D of body 14, moreover, may further enhance the debris-ingesting performance of valve 10.

The foregoing is provided for purposes of illustrating, explaining, and describing exemplary embodiments and certain benefits of the present invention. Modifications and adaptations to the illustrated and described embodiments will be apparent to those skilled in the relevant art and may be made without departing from the scope or spirit of the invention.

What is claimed is:

1. A valve having an inlet and an outlet and comprising a body defining a fluid passage therethrough, the body comprising (i) a flexible wall and (ii) a mouth intermediate the inlet and the outlet, the mouth comprising a plurality of lobes defined by the flexible wall.

2. A valve according to claim 1 in which the mouth assumes a substantially closed position absent a pressure differential outside and inside the wall.

3. A valve according to claim 2 in which the body has a maximum internal diameter and which, when outside and inside the wall are subject to substantial pressure differential in use, the mouth expands to a diameter approximating that of the maximum internal diameter.

4. A valve according to claim 3 further comprising means for connection to one or more components of an automatic swimming pool cleaner.

5. A valve according to claim 4 further comprising at least one stiffener formed with or attached to the wall.

6. A valve according to claim 5 in which the at least one stiffener is a rib extending longitudinally from adjacent the outlet to adjacent the mouth.

7. A valve according to claim 6 in which the body is generally tubular in shape and has an internal diameter that varies along its length.

8. A valve according to claim 7 in which the lobes of the plurality of lobes intersect at the transverse center of the fluid passage at an angle other than zero or one hundred eighty degrees.

9. A valve according to claim 8 in which the plurality of lobes comprises at least three lobes.

10. A valve according to claim 1 in which the lobes of the plurality of lobes intersect at the transverse center of the fluid passage at an angle other than zero or one hundred eighty degrees.

11. A valve according to claim 1 in which the plurality of lobes comprises at least three lobes.

12. An automatic swimming pool cleaner comprising a valve according to claim 1.
